(19) United States
(12) Patent Application Publication
(10) Pub. No.: US 2025/0018333 A1
(43) Pub. Date: Jan. 16, 2025

(54) CONTAMINANT REMOVAL FROM A MOBILE ATMOSPHERE USING REGENERATIVE LIQUID SORBENT

(71) Applicant: Honeywell International Inc., Charlotte, NC (US)

(72) Inventors: Rebecca Kamire, Buffalo Grove, IL (US); Phoebe Henson, Glendale, AZ (US)

(21) Appl. No.: 18/516,314

(22) Filed: Nov. 21, 2023

Related U.S. Application Data
(60) Provisional application No. 63/513,810, filed on Jul. 14, 2023.

(51) Int. Cl. B01D 53/22; B01D 53/14; B01D 53/18; B01J 6/00; B01J 12/00; B64G 1/48; C01B 3/24

(52) U.S. Cl. CPC B01D 53/229; B01D 53/1425; B01D 53/18; B01J 6/008; B01J 12/00; B64G 1/48; C01B 3/24; B01D 2257/504; B01D 2257/80; B01D 2259/4575; C01B 2203/0272; C01B 2203/1241

(57) ABSTRACT

A mobile contaminant removal system includes a contaminant sorption system of a mobile atmosphere. The contaminant sorption system includes at least one scrubber and a liquid sorbent loop. The at least one scrubber includes a membrane separator and is configured to receive a spent air stream from a ventilation system of the mobile atmosphere, absorb one or more contaminants from the spent air stream into a liquid sorbent, and discharge a clean air stream to the ventilation system. In an absorption mode, the liquid sorbent loop circulates the liquid sorbent through the at least one scrubber in a closed loop. In a regeneration mode, the liquid sorbent loop discharges the liquid sorbent to a system external to the mobile atmosphere, such as a liquid sorbent storage system or a liquid sorbent regeneration system.

This application claims the benefit of U.S. Provisional Application No. 63/513,810, entitled “CONTAMINANT REMOVAL FROM A MOBILE ATMOSPHERE USING REGENERATIVE LIQUID SORBENT” and filed on Jul. 14, 2023, which is incorporated herein by reference in its entirety.

### GOVERNMENT RIGHTS

This invention was made with Government support under Grant Contract Number 80MSFC18C0045 awarded by National Aeronautics and Space Administration (NASA) Marshall Space Flight Center. The Government has certain rights in the invention.

### TECHNICAL FIELD

The present disclosure relates to systems and techniques for removing contaminants from a mobile atmosphere, such as a spacesuit or vehicle, using contaminant removal systems.

### BACKGROUND

A primary life support system (PLSS) of a spacesuit may provide basic life support functions for an astronaut including spacesuit pressure regulation; oxygen supply, cooling, and recirculation; contaminant removal; cooling water recirculation; and communications and telemetry. An amount of extravehicular activity (EVA) of the astronaut may be limited by an ability of the contaminant removal system to remove carbon dioxide emitted by the astronaut from a recirculated air stream. To remove carbon dioxide from the recirculated air stream, a contaminant control cartridge containing lithium hydroxide may react with the carbon dioxide to form lithium carbonate and water. However, these contaminant control cartridges are non-regenerable, such that extravehicular activity may be limited to ten hours or less and require a return to a station to replace the cartridge. Alternatives to the contaminant control cartridge may use regenerable sorbents for absorbing and desorbing contaminants. However, these alternatives may not sufficiently separate the astronaut from a space vacuum, such that catastrophic failure of a component separating the astronaut from the space vacuum may be fatal.

As one example, a rapid cycle amine (RCA) system may include a swing-bed, vacuum regenerated process that uses a solid amine sorbent. A first bed may absorb carbon dioxide and humidity from an air stream, while a second bed may desorb the carbon dioxide and humidity into space vacuum. The two beds may alternate these absorption and desorption functions through a system of valves. However, this system of valves may pose a safety risk to the astronaut, as failure of a valve may expose the astronaut to space vacuum.

As another example, a membrane system may include a membrane with an ionic liquid impregnated in pores of the membrane. The ionic liquid may absorb carbon dioxide and humidity from the air stream on a first side of the membrane and desorb the carbon dioxide and humidity into space vacuum on a second, opposite side of the membrane. However, this relatively thin membrane may be the sole containment between the astronaut and space vacuum, such that failure of the membrane may expose the astronaut to space vacuum. Further, such membrane may not adequately contain the ionic liquid, limiting a lifetime of the membrane.

In the examples of the RCA system and the membrane system, contaminants that may otherwise be recycled and recovered may be lost to the space vacuum.

### SUMMARY

The disclosure describes systems and techniques for removing contaminants from a ventilation system of a mobile atmosphere, such as a spacesuit or vehicle, using a liquid sorbent and recovering at least a portion of the contaminants from the liquid sorbent by a system external to the mobile atmosphere. The mobile atmosphere includes a contaminant removal system to remove one or more contaminants from the ventilation system (or cabin). The contaminant removal system may treat the contaminant-containing air using one or more membrane separators to absorb contaminants from the air into a liquid sorbent. The liquid sorbent may circulate through a closed liquid sorbent loop, such that failure of a membrane, valve, or other separation component may not expose the astronaut to space vacuum. The loaded liquid sorbent may be discharged from the mobile atmosphere to a contaminant regeneration system that desorbs the contaminants from the liquid sorbent using a membrane separator. The desorbed contaminants may be recovered and further processed, such as by a Sabatier system. As such, contaminant capture systems discussed herein may be safe, durable, and regenerable.

In some examples, the disclosure describes a mobile contaminant removal system. The mobile contaminant removal system includes a contaminant sorption system of a mobile atmosphere. The contaminant sorption system includes at least one scrubber and a liquid sorbent loop. The at least one scrubber includes a membrane separator and is configured to receive a spent air stream from a ventilation system of the mobile atmosphere, absorb one or more contaminants from the spent air stream into a liquid sorbent, and discharge a clean air stream to the ventilation system. The liquid sorbent loop is configured with an absorption mode and a regeneration mode. In the absorption mode, the liquid sorbent loop circulates the liquid sorbent through the at least one scrubber in a closed loop. In the regeneration mode, the liquid sorbent loop discharges the liquid sorbent to a system external to the mobile atmosphere, such as a liquid sorbent storage system or a liquid sorbent regeneration system.

In some examples, the disclosure describes a contaminant capture system that includes one or more mobile contaminant removal systems and a contaminant recovery system. Each mobile contaminant removal system includes a contaminant sorption system of a mobile atmosphere that is configured to remove a contaminant using a liquid sorbent and discharge the liquid sorbent to a system external to the mobile atmosphere, such as the contaminant recovery system. The contaminant recovery system is configured to recover the contaminant from the liquid sorbent, and includes a liquid sorbent regeneration system configured to receive the liquid sorbent from the contaminant sorption system and remove the contaminant from the liquid sorbent into a contaminant stream.

In some examples, the disclosure describes a method for capturing a contaminant from a mobile atmosphere that includes an absorption mode and a regeneration mode. During the absorption mode, the method includes removing, by a contaminant sorption system, one or more contaminants from a spent air stream of a ventilation system of the spacesuit using a liquid sorbent. During the regeneration mode, the method includes discharging, by the contaminant sorption system, the liquid sorbent to a system external to the mobile atmosphere.

### BRIEF DESCRIPTION OF THE FIGURES

The details of one or more examples are set forth in the accompanying drawings and the description below. Other features, objects, and advantages will be apparent from the description and drawings, and from the claims.

FIG. 1 is a schematic block diagram illustrating an example contaminant capture system configured to remove and recover contaminants from a mobile atmosphere.

FIG. 2A is a schematic block diagram illustrating an example mobile contaminant removal system as part of a spacesuit.

FIG. 2B is a schematic block diagram illustrating an example mobile contaminant removal system as part of a vehicle.

FIG. 3 is a schematic block diagram illustrating an example contaminant recovery system as part of a station.

FIG. 4 is a schematic block diagram illustrating an example contaminant recovery system as part of a vehicle and a station.

FIG. 5 is a schematic diagram illustrating an example contaminant sorption system of a contaminant removal system.

FIG. 6 is a schematic diagram illustrating an example liquid sorbent regeneration system and a contaminant processing system of a contaminant recovery system.

FIG. 7A is a flowchart illustrating a method for removing contaminants from a ventilation system of a mobile atmosphere.

FIG. 7B is a flowchart illustrating a method for recovering contaminants from a mobile atmosphere.

### DETAILED DESCRIPTION

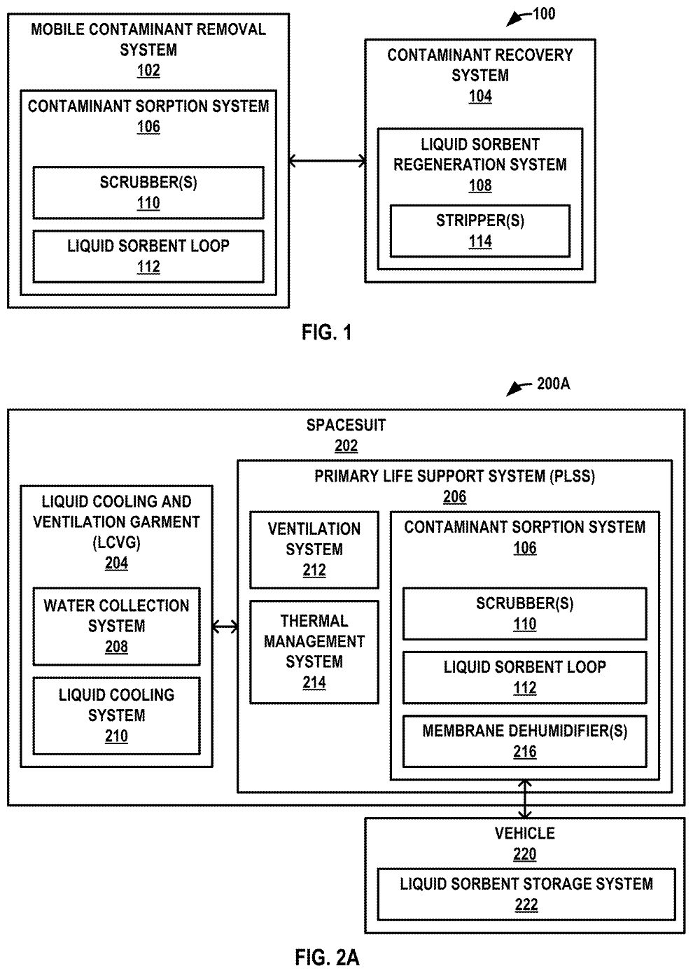

FIG. 1 is a schematic block diagram illustrating an example contaminant capture system 100 configured to remove and recover contaminants from a mobile atmosphere, such as a spacesuit or a vehicle that includes an atmosphere. System 100 includes a mobile contaminant removal system 102 as a mobile component that supports an astronaut on extra-vehicular activity (EVA) and a contaminant recovery system 104. Mobile contaminant removal system 102 is configured to capture contaminants from the mobile atmosphere while an astronaut is operating in a space environment detached from a station or other potential source of life support.

Contaminant sorption system 106 is configured to remove contaminants from air in a mobile atmosphere using a liquid sorbent. Contaminant removal system includes at least one scrubber 110 and a liquid sorbent loop 112. Scrubber 110 is configured to receive a spent air stream from a ventilation system of a mobile atmosphere, such as a spacesuit or a cabin of a vehicle configured to operate in a space environment, such as an air stream that includes exhaled air from an astronaut, absorb one or more contaminants from the spent air stream into an ionic liquid sorbent, and discharge a clean air stream back to the ventilation system of the mobile atmosphere. Liquid sorbent loop 112 is capable of continuous scrubbing of contaminants from the spent air in scrubber 110 to produce clean air.

Rather than discharge removed contaminants from the mobile atmosphere, contaminant sorption system 106 is configured to absorb the contaminants into the liquid sorbent in a closed loop and discharge the contaminants to a contaminant recovery system 104 while absorbed in the liquid sorbent. Liquid sorbent loop 112 is configured to operate in an absorption mode and a regeneration mode. In the absorption mode, liquid sorbent loop 112 may be configured to circulate the liquid sorbent through scrubber 110 to drive a gradient across one or more membranes of scrubber 110. In the regeneration mode, liquid sorbent loop 112 may be configured to discharge the liquid sorbent to a system external to the mobile atmosphere for regeneration of the loaded liquid sorbent or replacement of the loaded liquid sorbent with unloaded liquid sorbent. This system may include liquid sorbent regeneration system 108, or may include an intermediate storage system for storing the liquid sorbent and transported to liquid sorbent regeneration system 108 such that the liquid sorbent may be regenerated and the contaminants removed from the liquid sorbent. In some instances, as part of the regeneration mode, liquid sorbent loop 112 is configured to receive unloaded liquid sorbent from the system external to the mobile atmosphere. For example, unloaded liquid sorbent may be received directly from liquid sorbent regeneration system 108, or may be transported in a vessel to contaminant sorption system 106. The unloaded liquid sorbent may enable an astronaut to continue to operate in a space environment beyond a capacity of the liquid sorbent in contaminant sorption system 106. Once discharged, the liquid sorbent may either be stored and replaced with clean liquid sorbent or scrubbed and returned to the mobile atmosphere as recharged liquid sorbent.

Contaminant recovery system 104 is configured to recover contaminants from the liquid sorbent received from one or more spacesuits or other mobile environments, such as cabins. Contaminant recovery system 104 includes a liquid sorbent regeneration system 108 configured to receive the liquid sorbent from contaminant sorption system 106 and remove the contaminants from the liquid sorbent into a contaminant stream that may be stored or further processed. Liquid sorbent regeneration system 108 includes at least one stripper 114 configured to receive loaded liquid sorbent from contaminant sorption system 106, desorb the contaminants from the liquid sorbent into the contaminant stream, and discharge the contaminant stream, such as to a contaminant storage system or contaminant processing system. In this way, contaminants captured during EVA may be recovered for storage, recycling, or conversion.

In some examples, neither contaminant sorption system 106 nor liquid sorbent regeneration system 108 may be configured to operably discharge the contaminant to a space vacuum. For example, contaminant sorption system 106 may continually absorb contaminants into the liquid sorbent and periodically discharge loaded liquid sorbent once EVA is complete, while liquid sorbent regeneration system 108 may receive loaded liquid sorbent and remove the contaminants for further processing. As a result, contaminant sorption system 106 may remain separation from the space vacuum throughout EVA, and liquid sorbent regeneration system 108 may recover contaminants for storage, recycling, or conversion.

Scrubber 110 and stripper 114 include one or more membrane separators. Membrane separators discussed herein may include one or more membrane contactors configured to flow or expose contaminated air on a first side and flow liquid sorbent on a second, opposite side. The high surface area of the hollow fiber membrane contactors enables a high mass transfer of contaminants from a ventilation system of a mobile atmosphere into the liquid sorbent using a relatively small system volume and weight. Such contaminants may include, but are not limited to, carbon dioxide, water, bioeffluents, an alcohol, a hydrocarbon, a ketone, a halocarbon, or ammonia. The material of the hollow fibers may be selected such that the liquid sorbent does not wet the pores, and the trans-membrane pressure is kept sufficiently low to prevent pore penetration. As a result, the membrane contactor may ensure that the liquid sorbent and gas stream do not need further separation, such that contaminant sorption system 106 may act in a relatively gravity-independent way. In some examples, the liquid sorbent may be an ionic liquid sorbent. Such ionic liquid sorbents may be salts that are generally comprised of an anion and organic cation. These salts may be liquid at their temperature of use, have effectively zero vapor pressure, be generally nontoxic, and/or have sufficient stability to resist deterioration. Liquid sorbents may be water soluble, hygroscopic (i.e., capable of absorbing moisture from the air), and/or capable of releasing water by evaporation, such as by elevating the temperature or reducing the water partial pressure. In some instances, an ionic liquid sorbent may have a regeneration temperature that is lower and/or a regenerate rate that is higher than other sorbents, such as amine sorbents.

By using a continuous, regenerable liquid sorbent, mobile contaminant removal system 102 may remove contaminants from a mobile atmosphere with or without a vehicle or station, and may have increased EVA duration, reduced severity of component failure, reduced complexity, and/or reduced size compared to mobile atmospheres that do not use a regenerable liquid sorbent system. For example, because the liquid sorbent is continually absorbed by scrubber 110, an inventory of liquid sorbent in the liquid sorbent loop may be relatively small. As such, contaminant removal system 100 discussed herein may have smaller size and lower weight, especially for relatively long EVA sessions, and may enable further recovery of contaminants.

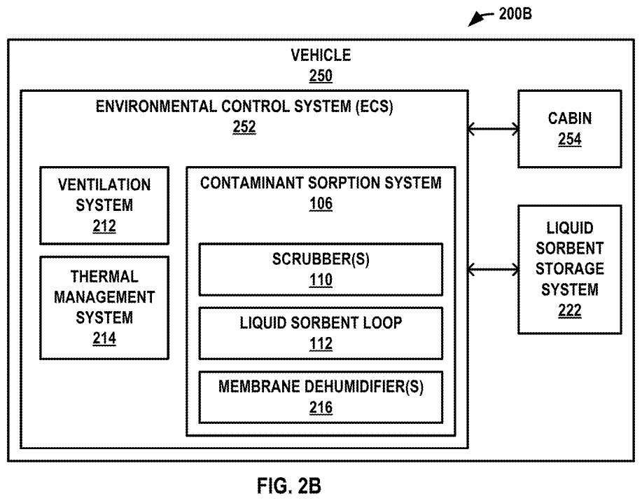

FIG. 2A is a schematic block diagram illustrating an example mobile contaminant removal system 200, such as mobile contaminant removal system 102 of FIG. 1. As will be described further below, mobile contaminant removal system 200A may include one or more systems configured to perform functions related to contaminant removal using a liquid sorbent and, in some examples, liquid sorbent storage.

Mobile contaminant removal system 200A may be implemented in an extra-vehicular activity system. The EVA system includes a spacesuit 202, such as may be worn by an individual, such as an astronaut, for EVA tasks external to a space vehicle 220. Spacesuit 202 may be configured to protect the individual in a vacuum environment, such as a space vacuum environment (e.g., less than about 2.5×10⁻⁴ torr). Spacesuit 202 includes a primary life support system (PLSS) 206 and a liquid cooling and ventilation garment (LCVG) 204. LCVG 204 may be worn over skin of the astronaut, while PLSS 206 may be worn over LCVG 204 and on a back and/or shoulders of the astronaut.

LCVG 204 may be configured to remove heat and/or waste fluid from the astronaut. LCVG 204 is illustrated as including a water collection system 208 and a liquid cooling system 210; however, LCVG 204 may include other systems that perform heat and/or waste fluid removal functions. Water collection system 208 may be configured to remove sweat from the astronaut and store the sweat or supply the sweat to other systems. Liquid cooling system 210 may be configured to receive cooling fluid from PLSS 206, such as from a thermal management system 214, remove heat from the astronaut using the cooling fluid, and discharge the warmed cooling fluid back to PLSS 206.

PLSS 206 may be configured to provide life support to the astronaut. PLSS 206 may provide functions that include, but are not limited to: regulating pressure of spacesuit 202; supplying, cooling, and recirculating oxygen to the astronaut; cooling and recirculating air and water to LCVG 204; removing contaminants from recirculated oxygen and discharging the contaminants as a contaminant stream; and providing telecommunications and telemetry from spacesuit 202. Spacesuit 202 is illustrated as including ventilation system 212, contaminant sorption system 106, and thermal management system 214; however, PLSS 206 may include other systems that perform life support functions. Ventilation system 212 may be configured to supply oxygen to the astronaut and recirculate air from the astronaut to contaminant sorption system 106. For example, ventilation system 212 may discharge spent air to contaminant sorption system 106 and receive clean air from contaminant sorption system 106. Thermal management system 214 may be configured to cool and recirculate oxygen, water, and/or cooling fluid to and from LCVG 204 to maintain a temperature of the astronaut within a desired range. For example, thermal management system 214 may include one or more pumps, heat exchangers, and/or other equipment for cooling and/or circulating oxygen, water, and/or cooling fluid. In some examples, contaminant sorption system 106 may be configured to maintain the liquid sorbent at a temperature that further contributes to thermal management of the oxygen, water, and/or cooling fluid. PLSS 206 is configured to exchange liquid sorbent with a system external to spacesuit 202. In the example, of FIG. 2A, PLSS 206 may be configured to fluidically coupled to a liquid sorbent storage system 222 of a vehicle 220.

Mobile contaminant removal system 200A includes contaminant sorption system 106 as part of a spacesuit 202. Inclusion of contaminant sorption system 106 into spacesuit 202 may enable an astronaut to operate for an extended period of time without requiring discharge of contaminants from spacesuit 202. Contaminant sorption system 106 may be configured to permit an astronaut to engage in EVA for an extended period of time. For example, contaminant sorption system 106 may include a type and amount of the liquid sorbent that is sufficient to absorb contaminants for a particular period of time. The liquid sorbent may have a particularly high capacity for carbon dioxide, such that a large amount of carbon dioxide may be absorbed by the liquid sorbent before replacement of the liquid sorbent. In some examples, contaminant sorption system 106 may be configured to operate for at least four hours on a single charge of liquid sorbent. A volume of liquid sorbent used in contaminant sorption system 106 may be configured for a particular duration of EVA. In some examples, contaminant sorption system 106 may be configured to operate with a volume of liquid sorbent between about 1 liter and about 100 liters.

In some examples, contaminant sorption system 106 may further include one or more membrane dehumidifiers 216. For example, a water content of exhaled air may be relatively high, such that a volume of liquid sorbent may increase as water vapor is absorbed. At least a portion of the water vapor may be removed prior to absorption of contaminants at scrubber 110. Such removed water may be stored or used in other systems of spacesuit 202, such as other components of PLSS for humidity management.

Spacesuit 202 may be limited by an amount of liquid sorbent in liquid sorbent loop 112. To increase an amount of liquid sorbent available to spacesuit 202, mobile contaminant removal system 200A may include a liquid sorbent storage system 222 external to spacesuit 202. Liquid sorbent storage system 222 may be configured to receive loaded liquid sorbent from contaminant sorption system 106 and discharge unloaded liquid sorbent to contaminant sorption system 106. The unloaded liquid sorbent received by spacesuit 202 has a lower concentration of the one or more contaminants than loaded liquid sorbent discharged from spacesuit 202. In the example of FIG. 2A, liquid sorbent storage system 222 is located on a vehicle 220 external to spacesuit 202; in other examples, liquid sorbent storage system 222 may be located on a temporarily or permanently immobile structure, such as a stationary platform. As a result, access to liquid sorbent storage system 222 may increase the duration of a trip for vehicle 220, since carrying extra liquid sorbent may be more allowable with the extra size and weight of vehicle 220.

In operation, as the astronaut operates outside vehicle 220, contaminant sorption system 106 may continuously remove contaminants from ventilation system 212. Scrubber 110 may receive a spent air stream from ventilation system 212 that includes a relatively high concentration of contaminants, such as carbon dioxide or water. Liquid sorbent loop 112 may circulate the liquid sorbent through scrubber 110, such that contaminant sorption system 106 may operate without the use of frequently alternating valves (e.g., as in a swing bed operation), thereby reducing a number or severity of failure points in the system. Scrubber 110 may absorb the contaminant from the spent air stream into the liquid sorbent and discharge a clean air stream to ventilation system 212.

Once EVA ends or a contaminant in the liquid sorbent reaches a threshold, the astronaut may connect contaminant sorption system 106 to a system external to spacesuit 202, such as liquid sorbent storage system 222. Liquid sorbent loop 112 may discharge spent liquid sorbent to liquid sorbent storage system 222. If EVA is to be continued, Liquid sorbent loop 112 may draw unloaded liquid sorbent from liquid sorbent storage system 222. In other examples, the astronaut may connect contaminant sorption system 106 to a liquid sorbent regeneration system, such as liquid sorbent regeneration system 108 of FIG. 1.

FIG. 2B is a schematic block diagram illustrating an example mobile contaminant removal system 200B as part of a vehicle 250. In the example of FIG. 2B, vehicle 250 may include an environmental control system (ECS) 252 configured to maintain an atmosphere in a cabin 254 of vehicle 250. Like PLSS 206 of FIG. 2A. ECS 252 may be configured to provide life support to occupants of cabin 254 by controlling the atmosphere within cabin 254, such as through a ventilation system 212 and/or a thermal management system 214. ECS 252 may provide functions that include, but are not limited to: regulating pressure of cabin 254; supplying, cooling, and recirculating oxygen to the occupants of cabin 254; cooling and recirculating air and water to any regulation equipment of the occupants of cabin 254; removing contaminants from recirculated oxygen and storing the contaminants in liquid sorbent storage system 222; and providing telecommunications and telemetry from vehicle 250. By incorporating contaminant sorption system 106 on vehicle 250, vehicle 250 may be configured to operate in a space atmosphere for extended periods of time before loaded liquid sorbent may be replaced. For example, vehicle 250 may have a high weight and volume capacity. In some examples, liquid sorbent storage system 222 has a volume between about 100 liters and about 1000 liters.

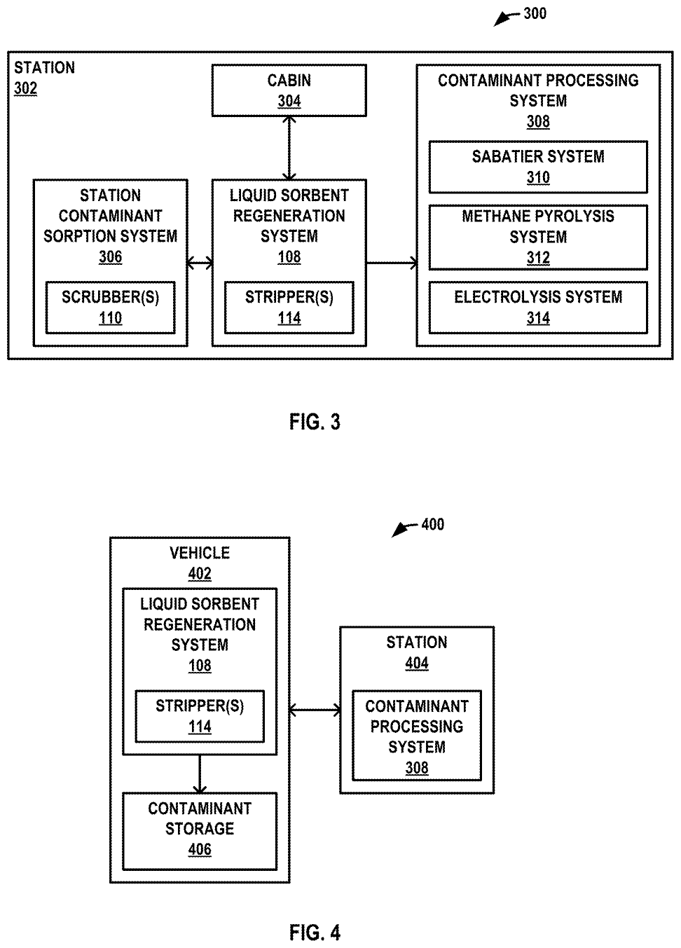

FIG. 3 is a schematic block diagram illustrating an example contaminant recovery system 300 as part of a station 302. Station 302 may include any temporarily or permanently positioned platform having a sufficient capacity for storing contaminants removed from one or more contaminant sorption system 106. For example, station 302 may include a space station, a ground station, a large vehicle, or other platform having a relatively sophisticated power and processing capability. Station 302 may be configured to interact with one or more mobile contaminant recovery systems, such as mobile contaminant recover system 102 of FIG. 1, each including contaminant sorption system 106.

Contaminant recovery system 300 is configured to recover contaminants from the liquid sorbent received by contaminant sorption systems 106, directly or via a storage system, such as liquid sorbent storage system 222 of FIG. 2A. Contaminant recovery system includes liquid sorbent regeneration system 108. Liquid sorbent regeneration system 108 is configured to receive the liquid sorbent from contaminant sorption system 106 and remove the contaminant from the liquid sorbent into a contaminant stream.

In some examples, liquid sorbent regeneration system 108 may also be configured to remove contaminants that are captured in station 302. For example, contaminant recovery system 300 may also include a station contaminant sorption system configured to remove one or more contaminants from an environment, such as a cabin 304. Like contaminant sorption system 106, station contaminant sorption system 306 may include one or more scrubbers 110 configured to absorb contaminants into the liquid sorbent, but on a larger scale. By consolidating contaminant recovery into a single liquid sorbent regeneration system 108, an overall volume and/or weight of contaminant recovery equipment may be lower.

In some examples, contaminant recovery system 300 further includes a contaminant processing system 308 fluidically coupled to liquid sorbent regeneration system 108. Contaminant processing system 308 may be configured to perform one or more processing or storage operations on contaminants removed from the liquid sorbent. In some examples, contaminant processing system 308 may be configured to generate carbon and oxygen from carbon dioxide removed by contaminant sorption system 106. In the example of FIG. 3, contaminant processing system 308 includes a Sabatier system 310, a methane pyrolysis system 312, and an electrolysis system 314. Sabatier system 310 is configured to generate methane gas and water from hydrogen gas and carbon dioxide. For example, a portion of the carbon dioxide in the contaminant stream may be supplied to Sabatier system 310, along with hydrogen gas produced by electrolysis system 314 or another source. Methane pyrolysis system 312 is configured to generate hydrogen gas and carbon from the methane gas produced by Sabatier system 310. For example, methane pyrolysis system 312 may pyrolyze the methane gas to deposit solid carbon on substrates and discharge the hydrogen gas. Electrolysis system 314 is configured to generate oxygen gas and hydrogen gas from water. For example, water generated from Sabatier system 310 may be separated from the methane gas and discharged to electrolysis system 314, where it undergoes electrolysis to generate the oxygen gas. In this way, contaminants removed during EVA, such as carbon dioxide and water, may be recycled as a closed loop.

While contaminant recovery system 300 of FIG. 3 is illustrated as being located at a same location, in some examples, contaminant recovery system described herein may be located at different locations, such that functions related to desorption of the contaminants from the liquid sorbent may be separated from functions related processing of the contaminants. FIG. 4 is a schematic block diagram illustrating an example contaminant recovery system 400 as part of a vehicle 402 and a station 404, in which vehicle 402 is configured to move with respect to station 404 and further support astronauts by providing additional capacity of liquid sorbent.

In the example of FIG. 4, liquid sorbent regeneration system 108 is located on vehicle 402 and is fluidically coupled to a contaminant storage system 406. Liquid sorbent regeneration system 108 may be configured to desorb contaminants from liquid sorbent received from contaminant sorption systems and discharge the contaminants to contaminant storage system 406. The unloaded liquid sorbent may be discharged to contaminant sorption systems 106 to further extend an amount of time a respective mobile atmosphere may spend in EVA. Contaminant processing system 308 is located at station 404. Contaminant processing system 308 may provide further processing functions that may not be related to regenerating liquid sorbent, such as generating carbon, hydrogen gas, or oxygen gas from the contaminants. Once vehicle 402 returns to station 404, vehicle may discharge contaminants from contaminant storage system 406.

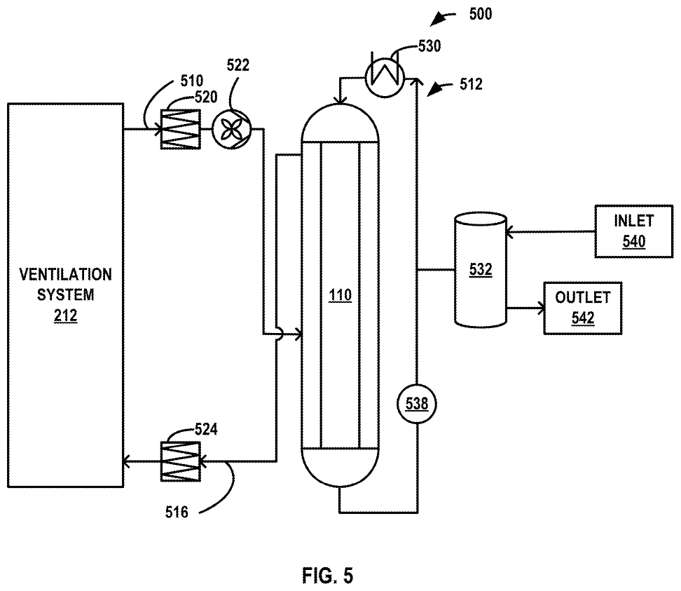

FIG. 5 is a schematic diagram illustrating an example contaminant sorption system 500, such as contaminant sorption system 106 of FIGS. 1 and 2. Contaminant sorption system 500 includes connections to systems outside contaminant sorption system 500, including ventilation system 212, a cooling system (not shown) for various heat transfer components, and a system external to the mobile atmosphere, such as liquid sorbent regeneration system 108.

Contaminant sorption system 500 includes an inlet configured to receive spent air stream 510 from ventilation system 212 and an outlet configured to discharge clean air stream 516 to ventilation system 212. Clean air stream 516 has a contaminant concentration that is lower than spent air stream 510. Clean air stream 516 may still include contaminants, though the contaminants would be below a threshold level for each contaminant. Contaminant sorption system 500 includes an inlet 540 and an outlet 542. Inlet 540 is configured to fluidically couple to a system external to the mobile atmosphere and discharge loaded liquid sorbent to the system. Outlet 542 is configured to fluidically couple to a system external to the mobile atmosphere and receive unloaded liquid sorbent from the system.

Contaminant sorption system 500 includes a ventilation air circuit configured to circulate air between ventilation system 212 and scrubber 110. In the example of FIG. 5, spent air stream 510 includes a filter 520 configured to remove particulates from spent air stream 510 prior to entry into scrubber 110 and a blower 522 configured to draw ventilation air into scrubber 110. In the example of FIG. 5, clean air stream 516 includes a filter 524 configured to remove any leaked liquid sorbent and/or further filter clean air from clean air stream 516 prior to entry into ventilation system 212. Clean air stream 516 may have a concentration of a contaminant that is about 25% to about 99% less than a concentration of the contaminant in spent air stream 510. In some examples, spent air stream 510 may have a carbon dioxide partial pressure between about 1 torr and about 15 torr.

Contaminant sorption system 500 includes a liquid sorbent loop 512 configured to circulate liquid sorbent through scrubber 110 in an absorption mode. For example, a pump 538 may be configured to pump liquid sorbent. In the absorption mode, pump 538 may pump clean liquid sorbent from a liquid sorbent storage 532 into scrubber 110. Clean liquid sorbent may include unused liquid sorbent free of contaminants or having a lower concentration of contaminants than the freshly loaded liquid sorbent.

Liquid sorbent loop 512 may also be configured to discharge loaded liquid sorbent from and/or draw unloaded liquid sorbent to contaminant sorption system 500 in a regeneration mode. Liquid sorbent loop 512 may be configured to discharge loaded liquid sorbent concurrently with the absorption mode. As one example, liquid sorbent loop 512 may continue to circulate liquid sorbent through scrubber 110 while the liquid sorbent is discharged from contaminant sorption system 500. As another example, liquid sorbent storage 532 may be configured to detach from liquid sorbent loop 512, such that liquid sorbent loop 512 may continue to circulate liquid sorbent through scrubber 110 while loaded liquid sorbent in liquid sorbent storage 532 is replaced with unloaded liquid sorbent, such as by switching vessels.

While liquid sorbent loop 512 is illustrated as including liquid sorbent storage 532, in some examples, liquid sorbent storage 532 may be separate from liquid sorbent loop 512. For example, liquid sorbent storage 532 may not be located on a spacesuit, or may be detachable from a spacesuit. By moving liquid sorbent storage 532 off the spacesuit, the spacesuit may have a lower weight and/or size, yet still be capable of periodically discharging loaded liquid sorbent and/or receiving unloaded liquid sorbent. As explained above, such replacement may be achieved by pumping liquid sorbent to and from a system external to the spacesuit, such as liquid sorbent storage system 222 of FIG. 2A or liquid sorbent regeneration system 108, or may be achieved by swapping in a vessel or other component of liquid sorbent storage 532 having loaded liquid sorbent with a vessel that includes unloaded liquid sorbent.

In the regeneration mode, pump 538 may discharge the loaded liquid sorbent from liquid sorbent storage 532 and, if further EVA is anticipated, replace the loaded liquid sorbent with unloaded liquid sorbent storage. In some examples, the clean liquid sorbent may be cooled by a cooler 530 prior to entry into scrubber 110. Cooler 530 may be fluidically coupled to a coolant loop, such as may be provided by a thermal management system (e.g., thermal management system 214 of FIG. 2A or 2B).

Contaminant sorption system 500 includes scrubber 110 between the ventilation air circuit and liquid sorbent loop 512. On a gas phase side, scrubber 110 is configured to receive spent air from spent air stream 510. Spent air from spent air stream 510 includes contaminants from ventilation system 212, such as carbon dioxide, water, and other gaseous substances. Scrubber 110 is configured to absorb one or more contaminant species in the spent air from spent air stream 510 into a liquid sorbent. Scrubber 110 includes one or more separation membranes, each configured to flow (e.g., provide or direct flow of) spent air from spent air stream 510 on a gas phase side of the respective membrane and flow a liquid sorbent on a liquid phase side of the membrane. Contaminants, such as carbon dioxide and/or water, may flow through the membrane due to a concentration gradient and become absorbed by the liquid sorbent, while the liquid sorbent may not substantially flow through the membrane. As a result, clean air discharged from scrubber 110 may have a lower concentration of contaminants than spent air received by scrubber 110. Scrubber 110 is configured to discharge clean air stream 516 to ventilation system 212. On a liquid phase side, scrubber 110 is configured to receive clean liquid sorbent. The clean liquid sorbent may flow through scrubber 110 and absorb contaminants from spent air of spent air stream 510 through the membrane(s) of scrubber 110. As a result, the used liquid sorbent discharged from scrubber 110 may have a higher concentration of contaminants than the clean liquid sorbent received by scrubber 110.

Contaminant sorption system 500 may include a process control system that includes a controller and one or more sensor sets. The controller may be communicatively coupled to and configured to receive measurement signals from one or more sensor sets and other process control components of contaminant sorption system 500, such as: control valves for spent air stream 510, clean air stream 516, and inlets/outlets to liquid sorbent storage 532 and cooler 530; pump 538; blower 522; and the like. The controller may include one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the operations described in this disclosure.

Sensor sets may include instrumentation configured to detect any of a pressure (e.g., pressure gauges), temperature, flow rate, and/or contaminant concentration (e.g., carbon dioxide concentration or water concentration) of a liquid or gas stream of contaminant sorption system 500. For a ventilation air circuit, a spent air sensor set may detect conditions of spent air stream 510 and a clean air sensor set may detect conditions of clean air stream 516. For liquid sorbent loop 512, a scrubber outlet sensor set may detect conditions of used liquid sorbent at an outlet of scrubber 110 and scrubber inlet sensor set may detect conditions of clean liquid sorbent at an inlet of scrubber 110.

In some examples, the controller is configured to control a contaminant concentration within the environment of ventilation system 212. For example, the controller may be configured to receive a contaminant concentration measurement for a contaminant and determine whether the contaminant concentration measurement exceeds a contaminant concentration setpoint. For example, the contaminant concentration setpoint may be a target concentration of clean air stream 516 for maintaining ventilation system 212 below a threshold contaminant concentration. The controller may be configured to send, in response to the contaminant concentration measurement exceeding the contaminant concentration setpoint, a control signal to decrease a concentration of the contaminant in clean air stream 516. For example, the controller may send a control signal to increase a flow rate of liquid sorbent, a temperature of the liquid sorbent, and/or any other variable that may increase a rate of removal of contaminants from spent air stream 510.

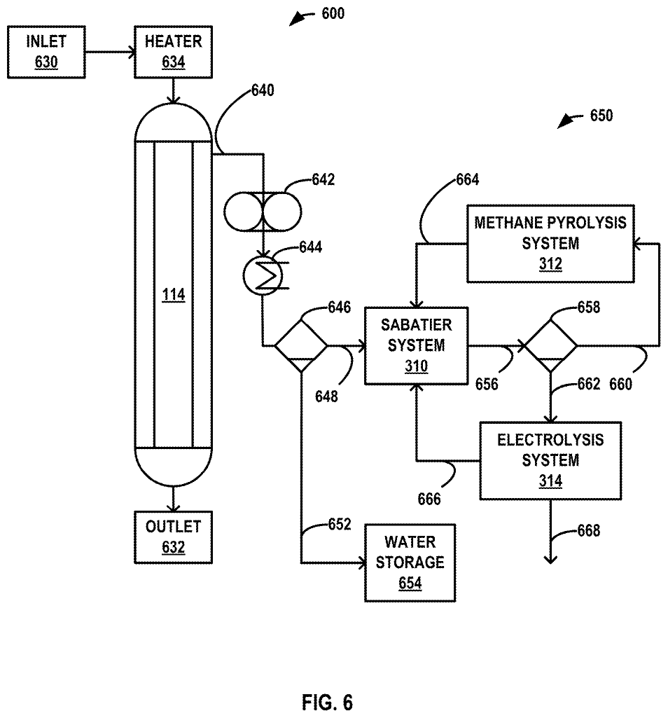

FIG. 6 is a schematic diagram illustrating an example liquid sorbent regeneration system 600 and a contaminant processing system 650 of a contaminant recovery system. Liquid sorbent regeneration system 600 includes connections to systems outside liquid sorbent regeneration system 600, including a cooling system (not shown) for various heat transfer components, contaminant processing system 650 via a contaminant stream 640, and one or more contaminant sorption systems 106.

Liquid sorbent regeneration system 600 includes an inlet 630 and an outlet 632. Inlet 630 is configured to fluidically couple to one or more contaminant sorption systems 106 and/or liquid sorbent storage systems (not shown) and receive loaded liquid sorbent from the one or more contaminant sorption systems 106 or liquid sorbent storage systems. Outlet 542 is configured to fluidically couple to the one or more contaminant sorption systems 106 and discharge unloaded liquid sorbent from the liquid sorbent regeneration system 600.

In some examples, the loaded liquid sorbent may be preheated by a heater 634 prior to entry into stripper 114. In some examples, heater 634 may heat the liquid sorbent to a relatively high temperature compared to contaminant removal systems that do not include separation between stripper 114 and ventilation system 212. In examples in which an ionic liquid sorbent is used, heater 634 may preheat the liquid sorbent to a relatively low temperature compared to other liquid sorbents, as the ionic liquid sorbents may have relatively low regeneration temperatures.

Liquid sorbent regeneration system 600 includes stripper 114 between inlet 630 and outlet 632 and contaminant processing system 650. On a liquid phase side, stripper 114 is configured to receive loaded liquid sorbent from inlet 630 and desorb one or more contaminants from the loaded liquid sorbent. Stripper 114 includes one or more membranes, each configured to flow the used liquid sorbent on one side of the membrane and contaminated air to contaminant stream 640 on an opposite side of the membrane. Contaminants may flow through the membrane due to a concentration gradient, while the liquid sorbent may not substantially flow through the membrane. As a result, clean liquid sorbent discharged from stripper 114 may have a lower concentration of contaminants than the used liquid sorbent received by stripper 114. On a gas phase side, stripper 114 is configured to discharge the contaminant in contaminant stream 640. Contaminant stream 640 may be continuously removed from stripper 114 to assist migration of the contaminants from the loaded liquid sorbent into contaminant stream 640.

Liquid sorbent regeneration system 600 may include a process control system that includes a controller and one or more sensor sets. The controller may be communicatively coupled to and configured to receive measurement signals from one or more sensor sets and other process control components of liquid sorbent regeneration system 600, such as: control valves for contaminant stream 640 and inlets/outlets to heater 634; and the like. The controller may include one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the operations described in this disclosure.

Sensor sets may include instrumentation configured to detect any of a pressure (e.g., pressure gauges), temperature, flow rate, and/or contaminant concentration (e.g., carbon dioxide concentration or water concentration) of a liquid or gas stream of liquid sorbent regeneration system 600. A stripper inlet sensor set may detect conditions of loaded liquid sorbent at an inlet of stripper 114 and a stripper outlet sensor set may detect conditions of unloaded liquid sorbent at an outlet of stripper 114.

Contaminant processing system 650 includes components to separate contaminants in contaminant stream 640. In the example of FIG. 6, contaminant processing system 650 includes a compressor 642, a condenser 644, and a water separator 646 configured to compress contaminant stream 640 and remove water from the compressed contaminant stream 640. For example, for carbon dioxide removed from liquid sorbent regeneration system 600 to be stored or recycled, compressor 642, condenser 644, and water separator 646 may compress contaminant stream 640 to a high pressure and remove nearly all water from contaminant stream 640.

Compressor 642 is configured to compress contaminant stream 640. A variety of compressors may be used for compressor 642 including, but not limited to, centrifugal compressors, positive displacement compressors, and the like. Condenser 644 may be configured to cool contaminant stream 640 and condense water from contaminant stream 640. For example, condenser 644 may be coupled to a refrigeration system or other cooling system that circulates a cooling medium to cool contaminant stream 640. A variety of condensers may be used for condenser 644 including, but not limited to, shell and tube heat exchangers, plate-fin, surface coolers, heat pipes, thermoelectric devices, cooling jackets, and the like. Water separator 646 may be configured to remove water from contaminant stream 640, discharge a dehumidified contaminant stream 648 to Sabatier system 310, and discharge water condensate stream 652 to a water storage system 654. A variety of water separators may be used for water separator 646 including, but not limited to, static phase separators, capillary phase separator, membrane phase separators, centrifugal/rotary separators, and the like.

Sabatier system 310 is configured to generate methane gas and water from hydrogen gas and carbon dioxide and discharge the methane gas and water as a product stream 656. A water separator 658 is configured to separate water from the methane gas, discharge a water stream 662 to electrolysis system 314, and discharge a methane gas stream 660 to methane pyrolysis system 312. Methane pyrolysis system 312 is configured to generate hydrogen gas and carbon from the methane gas produced by Sabatier system 310 and discharge the hydrogen gas in a hydrogen gas stream 664 to Sabatier system 310. For example, methane pyrolysis system 312 may pyrolyze the methane gas to deposit solid carbon on substrates in methane pyrolysis system 312. Electrolysis system 314 is configured to generate oxygen gas and hydrogen gas from water from water stream 662 and discharge oxygen gas into an oxygen stream 668 and a hydrogen gas stream 666 to Sabatier system 310.

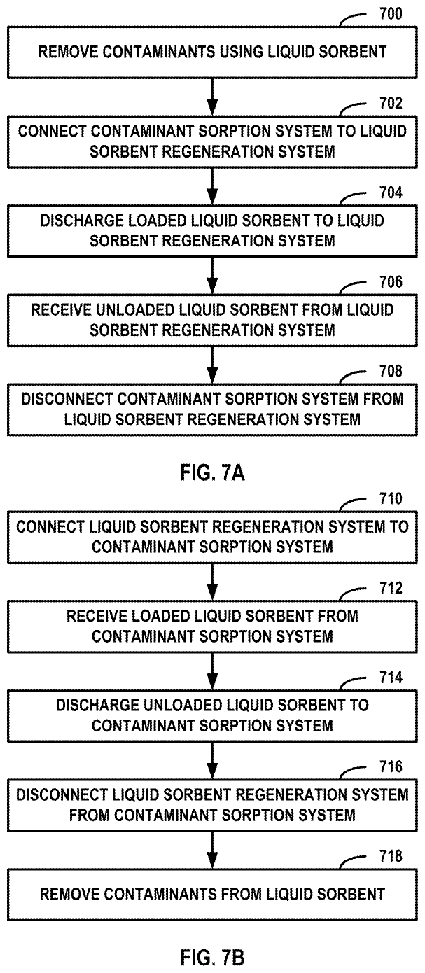

FIG. 7A is a flowchart illustrating a method for removing contaminants from a ventilation system of a mobile atmosphere, and will be described with respect to FIG. 1. The method of FIG. 7A includes, in an absorption mode, removing, by contaminant sorption system 106, one or more contaminants from a spent air stream of a ventilation system of a mobile atmosphere using a liquid sorbent (700). Removing the one or more contaminants may include receiving, by scrubber 110, the spent air stream, circulating, by liquid sorbent loop 112 the liquid sorbent through scrubber 110, absorbing, by scrubber 110, the one or more contaminants from the spent air stream into the liquid sorbent, and discharging, by scrubber 110, a clean air stream to the ventilation system.

The method of FIG. 7A further includes, in a regeneration mode, replacing the loaded liquid sorbent with unloaded liquid sorbent. This replacement includes prior to discharging the liquid sorbent, connecting contaminant sorption system 106 to a system external to the spacesuit, such as liquid sorbent regeneration system 108 (702). The method further includes discharging, by contaminant sorption system 106, the liquid sorbent to liquid sorbent regeneration system 108 (704). The method further includes receiving, by contaminant sorption system 106, unloaded liquid sorbent from liquid sorbent regeneration system 108 (706). The method further includes, after discharging the liquid sorbent, disconnecting contaminant sorption system 106 from liquid sorbent regeneration system 108 (708).

FIG. 7B is a flowchart illustrating a method for recovering contaminants from a mobile atmosphere, and will be described with respect to FIG. 1. The method of FIG. 7B further includes removing contaminants from loaded liquid sorbent of one or more contaminant sorption systems 106. This removal includes connecting liquid sorbent regeneration system 108 to contaminant sorption system 106 (710). The method further includes receiving, by liquid sorbent regeneration system 108, loaded liquid sorbent from contaminant sorption system 106 (712). The method further includes discharging, by liquid sorbent regeneration system 108, the liquid sorbent, such as to a liquid sorbent storage system or to contaminant sorption system 106 (714). The method further includes disconnecting liquid sorbent regeneration system 108 from contaminant sorption system 106 (716).

The method of FIG. 7B includes removing contaminants from the loaded liquid sorbent (718). Such removal may be done on a continuous or discontinuous bases. Removing the contaminants may include desorbing, by liquid sorbent regeneration system 108, the one or more contaminants from the liquid sorbent.

Example 1: A mobile contaminant removal system includes a contaminant sorption system of a mobile atmosphere, wherein the contaminant sorption system comprises: at least one scrubber includes receive a spent air stream from a ventilation system of the mobile space atmosphere; absorb one or more contaminants from the spent air stream into a liquid sorbent; and discharge a clean air stream to the ventilation system; and a liquid sorbent loop configured to: in an absorption mode, circulate the liquid sorbent through the at least one scrubber in a closed loop; and in a regeneration mode, discharge the liquid sorbent to a system external to the mobile atmosphere.

Example 2: The mobile contaminant removal system of example 1, wherein the liquid sorbent loop is configured to, in the regeneration mode, receive liquid sorbent from the system external to the mobile atmosphere.

Example 3: The mobile contaminant removal system of any of examples 1 and 2, further includes receive the liquid sorbent from the contaminant sorption system; and discharge the liquid sorbent to the contaminant sorption system, wherein the liquid sorbent received by the mobile atmosphere has a lower concentration of the contaminant than the liquid sorbent discharged from the mobile atmosphere.

Example 4: The mobile contaminant removal system of example 3, wherein the liquid sorbent storage system is located on a vehicle external to the mobile atmosphere.

Example 5: The mobile contaminant removal system of any of examples 1 through 4, wherein the contaminant sorbent system is not configured to operably discharge the contaminant to a space vacuum.

Example 6: The mobile contaminant removal system of any of examples 1 through 5, wherein the mobile atmosphere includes at least one of a spacesuit or a cabin of a vehicle configured to operate in a space environment.

Example 7: A contaminant capture system includes one or more mobile contaminant removal systems, wherein each mobile contaminant removal system comprises a contaminant sorption system of a mobile atmosphere, wherein the contaminant sorption system is configured to: remove a contaminant using a liquid sorbent; and discharge the liquid sorbent to a system external to the mobile atmosphere; and a contaminant recovery system configured to recover the contaminant from the liquid sorbent, wherein the contaminant recovery system comprises a liquid sorbent regeneration system configured to: receive the liquid sorbent from the contaminant sorption system; and remove the contaminant from the liquid sorbent into a contaminant stream.

Example 8: The contaminant capture system of example 7, wherein the contaminant sorption system comprises: at least one scrubber includes receive a spent air stream from a ventilation system of the mobile atmosphere; absorb a contaminant from the spent air stream into a liquid sorbent; and discharge a clean air stream to the ventilation system; and a liquid sorbent loop configured to: in an absorption mode, circulate the liquid sorbent through the at least one scrubber in a closed loop; and in a regeneration mode, discharge the liquid sorbent to a system external to the mobile atmosphere.

Example 9: The contaminant capture system of any of examples 7 and 8, wherein the liquid sorbent regeneration system comprises at least one stripper includes receive liquid sorbent from a contaminant removal system, wherein the liquid sorbent includes one or more contaminants; desorb the contaminant from the liquid sorbent into a contaminant stream; and discharge the contaminant stream.

Example 10: The contaminant capture system of example 9, wherein the one or more contaminants include carbon dioxide and water, and wherein the contaminant recovery system further comprises a contaminant processing system configured to: compress the contaminant stream; and remove water from the contaminant stream.

Example 11: The contaminant capture system of example 10, wherein the contaminant processing system further comprises: a Sabatier system configured to generate methane from hydrogen gas and carbon dioxide; a methane pyrolysis system configured to generate hydrogen gas and carbon from methane; and an electrolysis system configured to generate oxygen gas and hydrogen gas from water.

Example 12: The contaminant capture system of any of examples 10 and 11, wherein the liquid sorbent regeneration system is located on a vehicle and is fluidically coupled to a contaminant storage system, wherein the contaminant processing system is located at a station, and wherein the vehicle is configured to move with respect to the station.

Example 13: The contaminant capture system of any of examples 7 through 12, further comprising a station contaminant sorption system configured to remove one or more contaminants from a cabin using the liquid sorbent, wherein the liquid sorbent regeneration system is configured to remove contaminants from liquid sorbent from both the contaminant sorption system and the station contaminant sorption system.

Example 14: The contaminant capture system of any of examples 7 through 13, wherein the liquid sorbent regeneration system is not configured to operably discharge the one or more contaminants to a space vacuum.

Example 15: A method for capturing a contaminant from a mobile atmosphere includes during an absorption mode, removing, by a contaminant sorption system, one or more contaminants from a spent air stream of a ventilation system of the mobile atmosphere using a liquid sorbent; and during a regeneration mode, discharging, by the contaminant sorption system, the liquid sorbent to a system external to the mobile atmosphere.

Example 16: The method of example 15, further comprising, in the regeneration mode, receiving, by the contaminant sorption system, the liquid sorbent from the system external to the mobile atmosphere, wherein the liquid sorbent discharged has a lower concentration of the contaminant than the liquid sorbent received.

Example 17: The method of any of examples 15 and 16, further includes prior to discharging the liquid sorbent, connecting the contaminant sorption system to the system external to the mobile atmosphere; and after discharging the liquid sorbent, disconnecting the contaminant sorption system from the system external to the mobile atmosphere.

Example 18: The method of any of examples 15 through 17, further includes receiving, by a liquid sorbent regeneration system, liquid sorbent from the contaminant sorption system; and desorbing, by the liquid sorbent regeneration system, the one or more contaminants from the liquid sorbent.

Example 19: The method of any of examples 15 through 18, wherein removing the one or more contaminants further comprises: receiving, by at least one scrubber of the contaminant sorption system, the spent air stream; circulating, by a liquid sorbent loop of the contaminant sorption system, the liquid sorbent through the at least one membrane separator; absorbing, by the at least one scrubber, the one or more contaminants from the spent air stream into the liquid sorbent; and discharging, by the at least one scrubber, a clean air stream to the ventilation system.

Example 20: The method of any of examples 15 through 19, wherein the mobile atmosphere includes at least one of a spacesuit or a cabin of a vehicle configured to operate in a space environment.

Various examples have been described. These and other examples are within the scope of the following claims.

What is claimed is:

1. A mobile contaminant removal system, comprising:
a contaminant sorption system of a mobile atmosphere, wherein the contaminant sorption system comprises:
at least one scrubber comprising a membrane separator, wherein the at least one scrubber is configured to:
receive a spent air stream from a ventilation system of the mobile atmosphere;
absorb one or more contaminants from the spent air stream into a liquid sorbent; and
discharge a clean air stream to the ventilation system; and
a liquid sorbent loop configured to:
in an absorption mode, circulate the liquid sorbent through the at least one scrubber in a closed loop; and
in a regeneration mode, discharge the liquid sorbent to a system external to the mobile atmosphere.

2. The mobile contaminant removal system of claim 1, wherein the liquid sorbent loop is configured to, in the regeneration mode, receive liquid sorbent from the system external to the mobile atmosphere.

3. The mobile contaminant removal system of claim 1, further comprising a liquid sorbent storage system external to the mobile atmosphere, wherein the liquid sorbent storage system is configured to:
receive the liquid sorbent from the contaminant sorption system; and
discharge the liquid sorbent to the contaminant sorption system, wherein the liquid sorbent received by the mobile atmosphere has a lower concentration of the one or more contaminants than the liquid sorbent discharged from the mobile atmosphere.

4. The mobile contaminant removal system of claim 3, wherein the liquid sorbent storage system is located on a vehicle external to the mobile atmosphere.

5. The mobile contaminant removal system of claim 1, wherein the contaminant sorption system is configured to store the one or more contaminants.

6. The mobile contaminant removal system of claim 1, wherein the mobile atmosphere includes at least one of a spacesuit or a cabin of a vehicle configured to operate in a space environment.

7. A contaminant capture system, comprising:
one or more mobile contaminant removal systems, wherein each mobile contaminant removal system comprises a contaminant sorption system of a mobile atmosphere, wherein the contaminant sorption system is configured to:
remove one or more contaminants using a liquid sorbent; and
discharge the liquid sorbent to a system external to the mobile atmosphere; and
a contaminant recovery system configured to recover the one or more contaminants from the liquid sorbent, wherein the contaminant recovery system comprises a liquid sorbent regeneration system configured to:
receive the liquid sorbent from the contaminant sorption system; and
remove the one or more contaminants from the liquid sorbent into a contaminant stream.

8. The contaminant capture system of claim 7, wherein the contaminant sorption system comprises:
at least one scrubber comprising a membrane separator, wherein the at least one scrubber is configured to:
receive a spent air stream from a ventilation system of the mobile atmosphere;
absorb a contaminant from the spent air stream into a liquid sorbent; and
discharge a clean air stream to the ventilation system; and
a liquid sorbent loop configured to:
in an absorption mode, circulate the liquid sorbent through the at least one scrubber in a closed loop; and
in a regeneration mode, discharge the liquid sorbent to a system external to the mobile atmosphere.

9. The contaminant capture system of claim 7, wherein the liquid sorbent regeneration system comprises at least one stripper comprising a membrane separator, wherein the at least one stripper is configured to:
receive liquid sorbent from a contaminant removal system, wherein the liquid sorbent includes one or more contaminants;
desorb the one or more contaminants from the liquid sorbent into a contaminant stream; and
discharge the contaminant stream.

10. The contaminant capture system of claim 9,
wherein the one or more contaminants include carbon dioxide and water, and
wherein the contaminant recovery system further comprises a contaminant processing system configured to:
compress the contaminant stream; and
remove water from the contaminant stream.

11. The contaminant capture system of claim 10, wherein the contaminant processing system further comprises:
a Sabatier system configured to generate methane from hydrogen gas and carbon dioxide;
a methane pyrolysis system configured to generate hydrogen gas and carbon from methane; and
an electrolysis system configured to generate oxygen gas and hydrogen gas from water.

12. The contaminant capture system of claim 10,
wherein the liquid sorbent regeneration system is located on a vehicle and is fluidically coupled to a contaminant storage system,
wherein the contaminant processing system is located at a station, and
wherein the vehicle is configured to move with respect to the station.

13. The contaminant capture system of claim 7, further comprising a station contaminant sorption system configured to remove one or more contaminants from a cabin using the liquid sorbent, wherein the liquid sorbent regeneration system is configured to remove contaminants from liquid sorbent from both the contaminant sorption system and the station contaminant sorption system.

14. The contaminant capture system of claim 7, wherein the liquid sorbent regeneration system is configured to store the contaminant.

15. A method for capturing a contaminant from a mobile atmosphere, comprising:
during an absorption mode, removing, by a contaminant sorption system, one or more contaminants from a spent air stream of a ventilation system of the mobile atmosphere using a liquid sorbent; and
during a regeneration mode, discharging, by the contaminant sorption system, the liquid sorbent to a system external to the mobile atmosphere.

16. The method of claim 15, further comprising, in the regeneration mode, receiving, by the contaminant sorption system, the liquid sorbent from the system external to the mobile atmosphere, wherein the liquid sorbent discharged has a lower concentration of the one or more contaminants than the liquid sorbent received.

17. The method of claim 15, further comprising:
prior to discharging the liquid sorbent, connecting the contaminant sorption system to the system external to the mobile atmosphere; and
after discharging the liquid sorbent, disconnecting the contaminant sorption system from the system external to the mobile atmosphere.

18. The method of claim 15, further comprising:
receiving, by a liquid sorbent regeneration system, liquid sorbent from the contaminant sorption system; and
desorbing, by the liquid sorbent regeneration system, the one or more contaminants from the liquid sorbent.

19. The method of claim 15, wherein removing the one or more contaminants further comprises:
receiving, by at least one scrubber of the contaminant sorption system, the spent air stream;
circulating, by a liquid sorbent loop of the contaminant sorption system, the liquid sorbent through the at least one scrubber;
absorbing, by the at least one scrubber, the one or more contaminants from the spent air stream into the liquid sorbent; and
discharging, by the at least one scrubber, a clean air stream to the ventilation system.

20. The method of claim 15, wherein the mobile atmosphere includes at least one of a spacesuit or a cabin of a vehicle configured to operate in a space environment.
